(19) United States
(12) Patent Application Publication
(10) Pub. No.: US 2024/0417277 A1
(43) Pub. Date: Dec. 19, 2024

(54) WATER FILTRATION SYSTEMS AND DEVICES AND METHODS OF USING THE SAME

(71) Applicant: Jacob Ashpaugh, Indianapolis, IN (US)

(72) Inventor: Jacob Ashpaugh, Indianapolis, IN (US)

(21) Appl. No.: 18/740,791

(22) Filed: Jun. 12, 2024

Related U.S. Application Data
(60) Provisional application No. 63/472,870, filed on Jun. 14, 2023.

(51) Int. Cl. C02F 1/00; B01D 29/56; B01D 29/90; C02F 1/32; H01M 10/46; H02J 7/35

(52) U.S. Cl. CPC C02F 1/001; B01D 29/56; B01D 29/902; C02F 1/325; H01M 10/465; H02J 7/35; B01D 2201/26; C02F 2201/008; C02F 2201/009; C02F 2303/04; H01M 2220/30

(57) ABSTRACT

Water filtration systems and devices and methods of using the same. The present disclosure includes disclosure of a water purification system, comprising a portable case, an inlet configured to receive water for filtration, a first strainer configured to remove debris from the water for filtration, and a pump configured to pump water from the inlet, through the first strainer, through an in-line filter, and out of an outlet configured to discharge purified water.

### PRIORITY

The present application is related to, and claims the priority benefit of, U.S. Provisional Patent Application Ser. No. 63/472,870, filed Jun. 14, 2023, the contents of which are incorporated herein directly and by reference in their entirety.

### BRIEF SUMMARY

The present disclosure includes disclosure of a water purification system, as shown and/or described herein.

The present disclosure includes disclosure of a method to purify water using a water purification system, as shown and/or described herein.

The present disclosure includes disclosure of a water purification system, comprising a case having a solar panel thereon or embedded therein, the solar panel operably connected to a battery positioned within the case, an inlet configured to receive water for filtration, a water strainer configured to remove debris from the water for filtration, and a pump configured to pump water from the inlet, through the water strainer, through an in-line filter, and out of an outlet configured to emit filtered water.

The present disclosure includes disclosure of a water purification system, wherein the inlet is configured to receive an inlet hose thereon, the inlet hose having a debris screen for filtering debris.

The present disclosure includes disclosure of a water purification system, wherein the inlet is configured to receive an inlet flange, the inlet flange having an internal screen filter for filtering debris.

The present disclosure includes disclosure of a water purification system, powered using solar power obtained by the solar panel and stored within the battery.

The present disclosure includes disclosure of a water purification system, comprising a portable case, an inlet configured to receive water for filtration, a first strainer configured to remove debris from the water for filtration, and a pump configured to pump water from the inlet, through the first strainer, through an in-line filter, and out of an outlet configured to discharge purified water.

The present disclosure includes disclosure of a water purification system, wherein the first strainer comprises a large debris screen configured to remove sticks, leaves, and other large organic matter from the water for filtration.

The present disclosure includes disclosure of a water purification system, further comprising a second strainer comprising a water flange with an internal screen, the water flange positioned between the first strainer and the pump, the water flange configured to further screen particles within the water for filtration.

The present disclosure includes disclosure of a water purification system, further comprising a third strainer positioned between the second strainer and the pump, the third strainer comprising a screen configured to further screen particles within the water for filtration.

The present disclosure includes disclosure of a water purification system, further comprising an ultraviolet light filter positioned between the pump and the outlet, the ultraviolet light filter configured to kill bacteria and viruses remaining in the water for filtration after the water for filtration has been filtered through the in-line filter.

The present disclosure includes disclosure of a water purification system, wherein the in-line filter is configured to filter 99.99% of bacteria from the water for filtration.

The present disclosure includes disclosure of a water purification system, further comprising a battery configured to provide power to the pump.

The present disclosure includes disclosure of a water purification system, further comprising a charge controller in communication with the battery, the charge controller configured to regulate charging of the battery.

The present disclosure includes disclosure of a water purification system, further comprising a solar panel coupled to or embedded within the case, the solar panel operably connected to the battery positioned within the case and configured to charge the battery.

The present disclosure includes disclosure of a water purification system, comprising a portable case, an inlet configured to receive water for filtration, a first strainer configured to remove debris from the water for filtration, a second strainer comprising a water flange with an internal screen, the water flange positioned between the first strainer and the pump, the water flange configured to further screen particles within the water for filtration, a third strainer positioned between the second strainer and the pump, the third strainer comprising a screen configured to further screen particles within the water for filtration, a pump configured to pump water from the inlet, through the first strainer, through an in-line filter, and out of an outlet configured to discharge filtered water, a battery configured to provide power to the pump, and a charge controller in communication with the battery, the charge controller configured to regulate charging of the battery.

The present disclosure includes disclosure of a water purification system, further comprising an ultraviolet light filter positioned between the pump and the outlet, the ultraviolet light filter configured to kill bacteria and viruses remaining in the water for filtration after the water for filtration has been filtered through the in-line filter.

The present disclosure includes disclosure of a water purification system, wherein the in-line filter is configured to filter 99.99% of bacteria from the water for filtration.

The present disclosure includes disclosure of a water purification system, further comprising a solar panel coupled to or embedded within the case, the solar panel operably connected to the battery positioned within the case and configured to charge the battery.

The present disclosure includes disclosure of a method of purifying water, comprising the steps of introducing water into the inlet of the case of a system of the present disclosure, and operating the system to produce purified water.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a top view of a case of a system having a solar panel thereon, according to an exemplary embodiment of the present disclosure;

FIG. 2 shows a first side view of a case of a system, according to an exemplary embodiment of the present disclosure;

FIG. 3 shows a second side view of a case of a system, according to an exemplary embodiment of the present disclosure;

FIG. 4A shows a view of an open case of a system without a panel covering certain components therein, according to an exemplary embodiment of the present disclosure

FIG. 4B shows a view of an open case of a system having a panel covering certain components therein, according to an exemplary embodiment of the present disclosure;

FIGS. 5A and 5B show a view of an open case of a system without the panel covering certain components therein, according to an exemplary embodiment of the present disclosure; and

FIG. 6 shows a component diagram of certain portions of a system and elements connected thereto, according to an exemplary embodiment of the present disclosure.

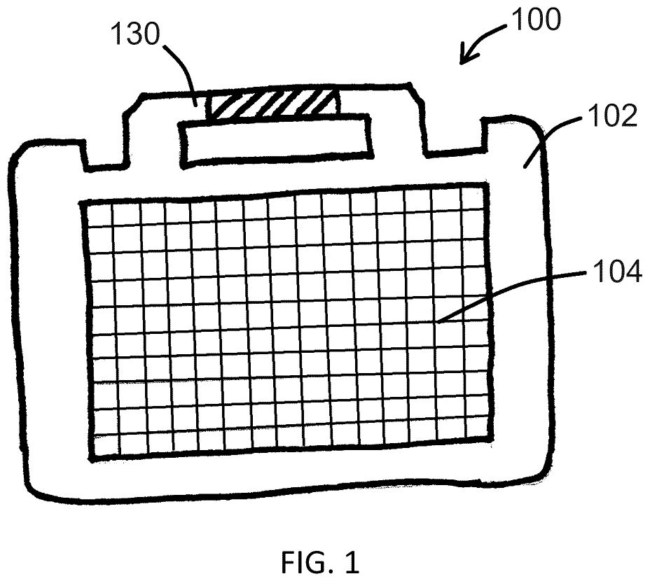

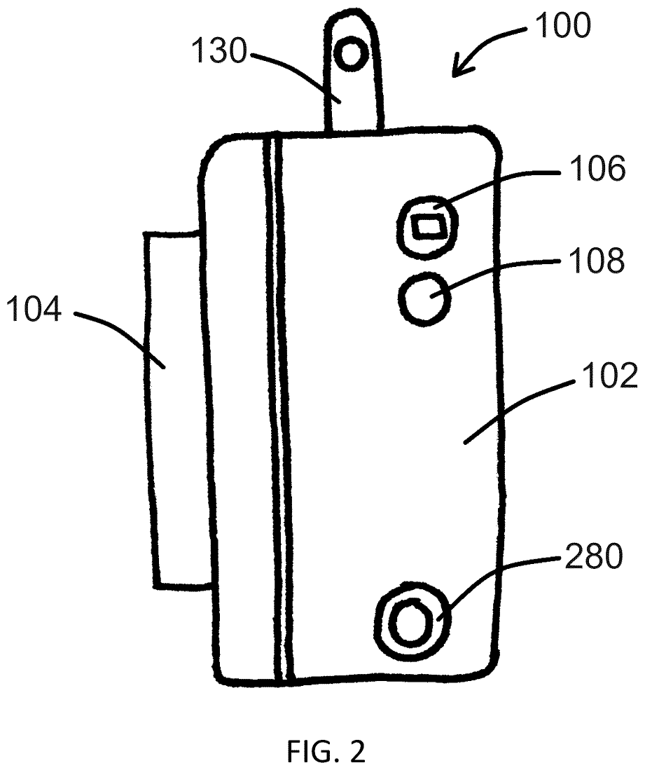

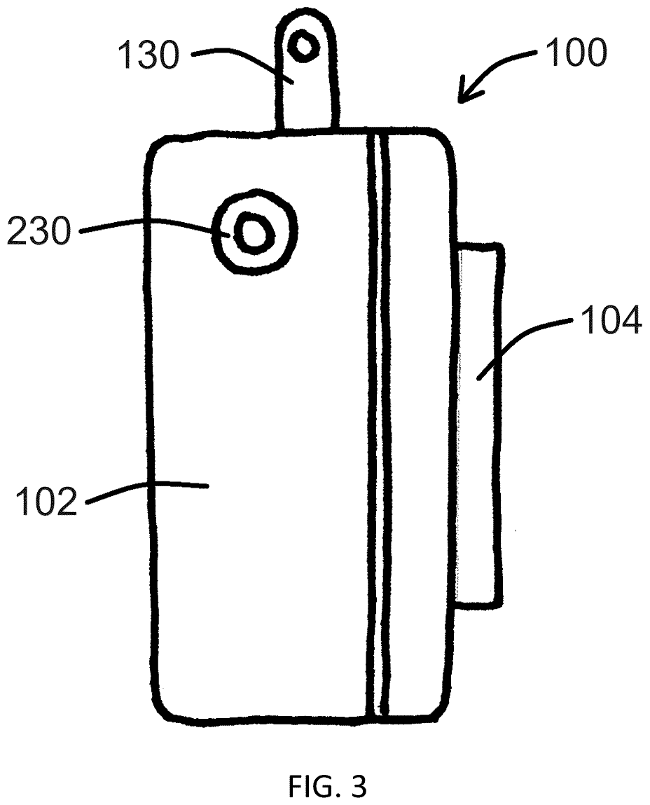

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of a portable, powered water filtration system. As shown and referenced herein, said system 100 comprises a small mobile portable water purifier that can be used in various emergency situations, natural disasters, contaminated water leaks, conflict zones, etc. It can also be used in non-emergency settings such as off-grid living, recreational and camper fresh water fill up, camping, and for the outdoor enthusiast.

Systems 100 of the present disclosure address the problem that there is plenty of water on the planet, but it is just not drinkable. Systems of the present disclosure can take water from creeks, ponds, rivers, swimming pools, contaminated public water, and non-potable water, and turn the same into safe drinking water. Said systems do this in a fast, large volume, and powered fashion that can provide water for a single camper, a whole family. or an entire group or village.

Filtration systems of the present disclosure have the capability of producing over 70 gallons of fresh water per hour. Said systems are self-contained and eco-friendly, being powered by the sun with the use of solar energy

Said systems can supply water for many years without the need for outside power or maintenance.

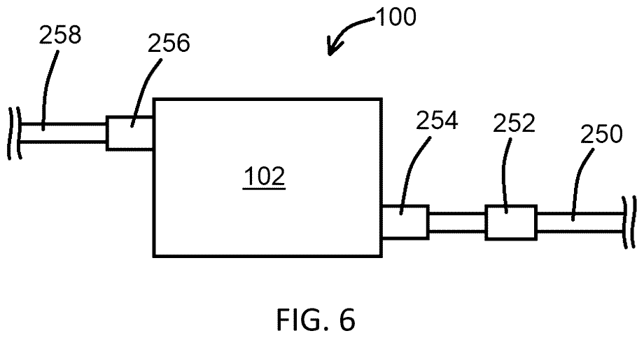

In use, and when the power button (on/off switch 110) is pressed, the system 100 immediately self-primes and starts transferring water. The water is gathered through an included ⅜″ flexible stainless hose (hose 250), such as shown in FIG. 6, but it is noted that other sizes of hoses 250 made of different materials may be used. The hose 250 has a large debris screen 252 that is the first line of protection. The debris screen 252 removes all large debris such as sticks, leaves, and other large organic matter. The hose 250 attaches to the unit by a ½″ MPT water flange 254 with a lead-free brass check valve/adapter 112, noting that different size flanges 254 with different types of valves may be used in various embodiments. Water flange 254 has an internal screen that is able to filter particles to 0.5 mm, which is the second line of protection.

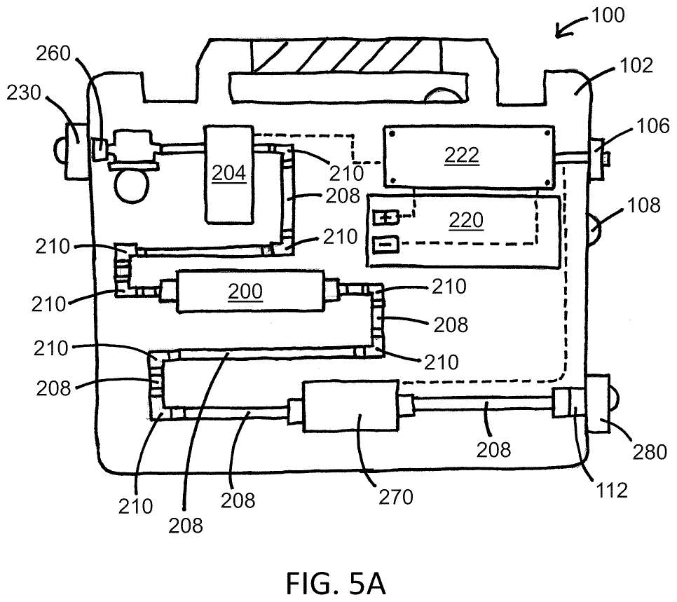

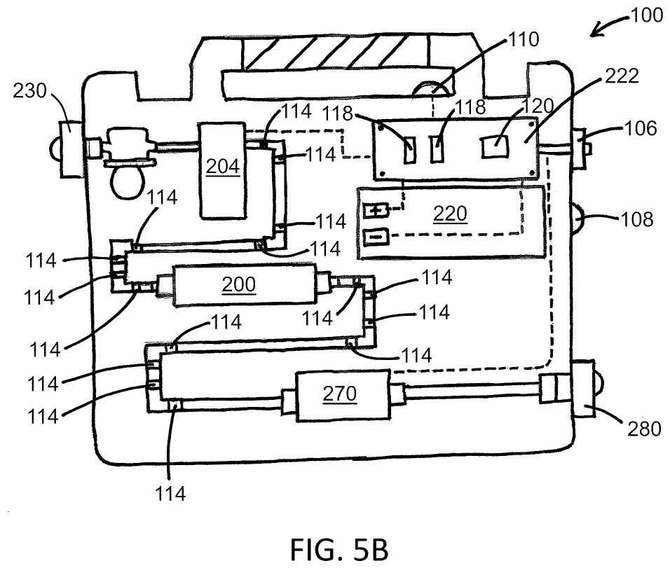

The water then passes through a water strainer 206, as shown in FIG. 5, with a very small 50 mesh (50 pieces of wire per inch) stainless steel screen to filter out even the smallest organic contaminates before entering the pump 204. This is the third line of defense. The water passes to the pump 204 via food grade brass valves and ⅜″ inner diameter (ID) beverage tubing with stainless steel clamps 114, noting that different types of valves and different size and type of tubing may be used.

The water then reaches the 12-volt 35 psi pump 204, which is one of any number of exemplary pumps that may be used in the present disclosure. The water is then pushed through a series of hoses 208 and PVC elbows (connectors 210) to reach the in-line filter 200. The in-line filter 200 is connected to the hoses 208 using two quick connect push button fittings 202 at each end for easy cleaning and filter replacement. The filter 200 is the fourth line of defense. It is effective for 99.99% of bacteria, 99.9% of protozoa, metals, plastics, and particulates. The water is then pushed out of the case 102 via a series of hoses and fittings. A standard ½″ water hose attachment (attachment 256) is on the outside of the case 102 on which to attach an exit hose 258 at outlet 280.

The water coming out of the system 100 via hose 258 is now safe and clean to drink. The unit (system 100) will push water over 50 ft and up to 6 ft vertical for all water filling needs. The unit is supplied with a 10-watt solar panel 104 which is attached to the case 102. The energy from the sun travels through the panel via cables and fuses 118 to a solar charge controller 116 to regulate charge for the battery 220. The power leaves the controller 116 and passes through more fuses 118 to supply the power to the lithium deep cell battery 220 that is used to power the unit. The unit also has an external quick connect charge port 106 for using additional solar sources or a standard 12-volt lithium house charger, for example. The outside of the case 102 also has an LED volt meter display 108 to monitor the battery 220 voltage. The case 102 has a push button off and on switch 110 for case of operation.

The wiring connections, fuses 118 and relays 120 are all housed in a water-resistant case 222 (also referred to herein as a fuse box 222), such as shown in FIG. 5, for safety. The unit contains vents 122 to prevent overheating as well as a plexiglass divider to separate the water components from the charge controller 116. All components can be housed in a 12″×16″ durable plastic case 102 with a handle 130 for strength and portability, for example.

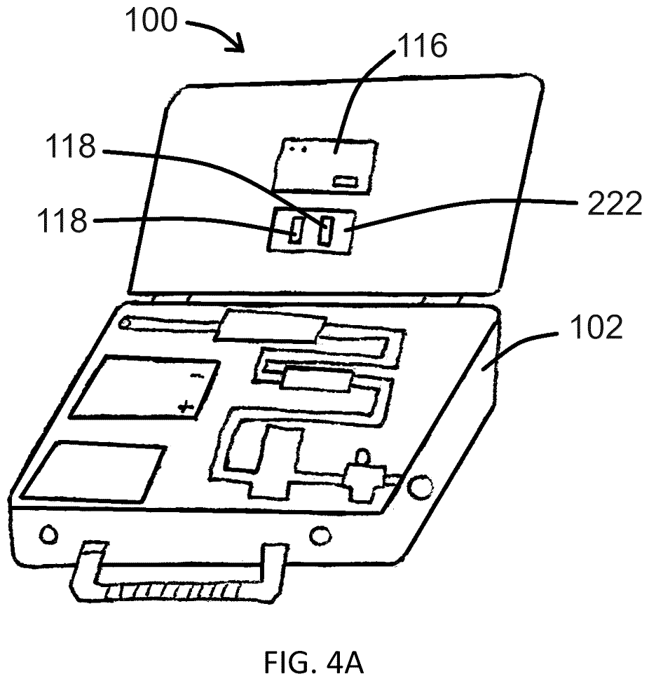

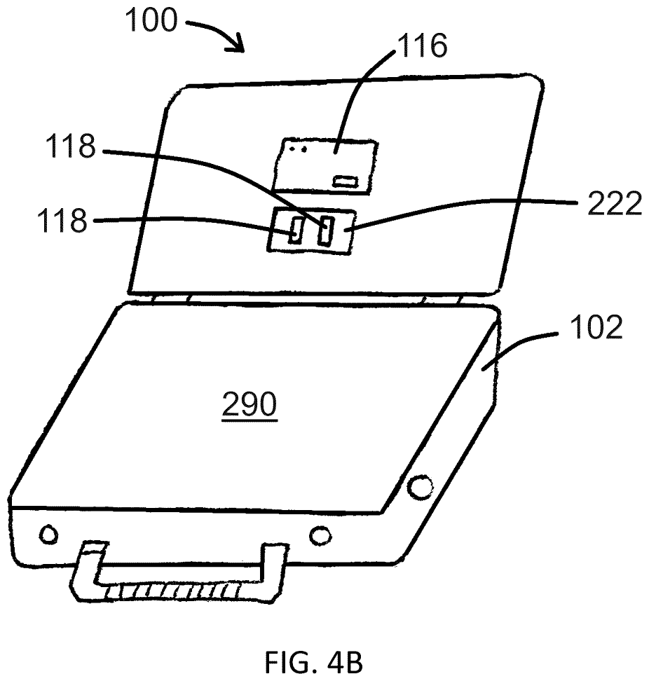

FIG. 4A shows a view of an open case of a system without a panel 290 covering certain components therein, while FIG. 4B shows a view of an open case of a system having a panel 290 covering certain components therein.

An exemplary embodiment of a system 100 of the present disclosure is shown in FIGS. 5A and 5B. As shown therein, system 100 can be housed within a portable case 102 so that system 100 can be used at any desired location. Case 102 has a water inlet 230 configured to receive a water supply hose 250, such as shown in FIG. 6, that supplies water to system 100. Supply hose 250 can comprise a large debris screen 252 (or be coupled to a large debris screen 252), also as shown in FIG. 6, that is the first line of protection/filtration, whereby said large debris screen 252 can remove large debris such as sticks, leaves, and other large organic and inorganic matter.

Supply hose 250 can attach to case 102 at inlet 230, which can comprise a water flange 254, such as shown in FIG. 6, which has an internal screen that is configured to filter particles down to 0.5 mm. This is the second line of protection/filtration.

Water then passes through a water strainer 260, such as shown in FIG. 5A, within case 102. Water strainer contains a small 50 mesh screen (or other smaller screen than the internal screen of water flange 254) that can filter out even the smallest organic contaminants before reaching pump 204. This is the third line of protection/filtration. The water then passes to the pump 204, such as a 12-volt 35 psi pump 204, which is one of any number of exemplary pumps 204 that may be used in the present disclosure. Pump 204 then causes the water to be pushed through a series of hoses 208 and PVC elbows (connectors 210) to reach the in-line filter 200. The in-line filter 200 can be connected to the hoses 208 using two quick connect push button fittings 202 at each end for easy cleaning and filter 200 replacement. The filter 200 is the fourth line of defense (protection/filtration). Filter 200 is effective for 99.99% of bacteria, 99.9% of protozoa, metals, plastics, and particulates.

In at least some embodiments, a fifth stage of protection/filtration is provided by way of an ultraviolet (UV) light filter 270 configured to kill any remaining bacteria or viruses that may be in the water after filtration using filter 200.

The water is then pushed out of the case 102 via a series of hoses 208 and fittings (connectors 210). A standard ½″ (or other size) water hose attachment (attachment 256) is on the outside of the case 102 on which to attach an exit hose 258 at outlet 280 of case 102, with exit hose 258 providing drinkable water.

While various embodiments water filtration systems and devices and methods of using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A water purification system, comprising:
a portable case;
an inlet configured to receive water for filtration;
a first strainer configured to remove debris from the water for filtration; and
a pump configured to pump water from the inlet, through the first strainer, through an in-line filter, and out of an outlet configured to discharge purified water.

2. The system of claim 1, wherein the first strainer comprises a large debris screen configured to remove sticks, leaves, and other large organic matter from the water for filtration.

3. The system of claim 2, further comprising:
a second strainer comprising a water flange with an internal screen, the water flange positioned between the first strainer and the pump, the water flange configured to further screen particles within the water for filtration.

4. The system of claim 3, further comprising:
a third strainer positioned between the second strainer and the pump, the third strainer comprising a screen configured to further screen particles within the water for filtration.

5. The system of claim 3, further comprising:
an ultraviolet light filter positioned between the pump and the outlet, the ultraviolet light filter configured to kill bacteria and viruses remaining in the water for filtration after the water for filtration has been filtered through the in-line filter.

6. The system of claim 1, wherein the in-line filter is configured to filter 99.99% of bacteria from the water for filtration.

7. The system of claim 1, further comprising:
a battery configured to provide power to the pump.

8. The system of claim 7, further comprising:
a charge controller in communication with the battery, the charge controller configured to regulate charging of the battery.

9. The system of claim 8, further comprising:
a solar panel coupled to or embedded within the case, the solar panel operably connected to the battery positioned within the case and configured to charge the battery.

10. A water purification system, comprising:
a portable case;
an inlet configured to receive water for filtration;
a first strainer configured to remove debris from the water for filtration;
a second strainer comprising a water flange with an internal screen, the water flange positioned between the first strainer and the pump, the water flange configured to further screen particles within the water for filtration;
a third strainer positioned between the second strainer and the pump, the third strainer comprising a screen configured to further screen particles within the water for filtration;
a pump configured to pump water from the inlet, through the first strainer, through an in-line filter, and out of an outlet configured to discharge filtered water;
a battery configured to provide power to the pump; and
a charge controller in communication with the battery, the charge controller configured to regulate charging of the battery.

11. The system of claim 10, further comprising:
an ultraviolet light filter positioned between the pump and the outlet, the ultraviolet light filter configured to kill bacteria and viruses remaining in the water for filtration after the water for filtration has been filtered through the in-line filter.

12. The system of claim 10, wherein the in-line filter is configured to filter 99.99% of bacteria from the water for filtration.

13. The system of claim 10, further comprising:
a solar panel coupled to or embedded within the case, the solar panel operably connected to the battery positioned within the case and configured to charge the battery.

14. A method of purifying water, comprising the step of:
introducing water into the inlet of the case of the system of claim 1; and
operating the system to produce purified water.
